(19) United States
(12) Patent Application Publication
(10) Pub. No.: US 2003/0074261 A1
(43) Pub. Date: Apr. 17, 2003

(54) Embedded payment for mobile printing

(76) Inventor: Corey J. Norris, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/976,533

(22) Filed: Oct. 11, 2001

(51) Int. Cl. G06F 17/60

(52) U.S. Cl. 705/17; 705/20; 705/39

(57) ABSTRACT

An electronic document is transferred to print media in exchange for payment. Payment account information is discovered. The payment account information is discovered either by reading the payment account information from an encoded magnetic strip or an optical strip or by receiving a transmission including the payment account information. The payment account information is optionally verified. Either after receiving the payment account information or after verifying the payment account information, the output apparatus is activated to accept and output the electronic document. Either after discovering the payment account information, verifying the payment account information, or activating the output apparatus, an electronic document is accepted. The electronic document is transferred to print media. A price is determined for accepting the electronic document and transferring the electronic document to print media. A payment transaction is executed with the payment information, at the determined price.

### FIELD OF THE INVENTION

This invention relates in general to mobile printing technology and, more particularly, to payment in a mobile printing system.

### BACKGROUND OF THE INVENTION

Battery powered computers, such as laptop and handheld computers, are often referred to as mobile computers. In recent years, mobile computer use has grown. As the mobile computer use has grown, so to has the demand for mobile printing solutions. Mobile printing solutions allow a mobile computer user to easily print a document

Many printers now include infrared ports. Many mobile computers also have an infrared port. A document may be transmitted between the mobile computer and the printer using the infrared ports. The printer then prints the document. The infrared port is a convenient solution for allowing mobile computer users to print documents. However, mobile computer users often do not have access to a printer they may use without charge.

Conventional printing solutions for mobile computer users include enrollment based services and printing shops. In an enrollment based service, a mobile computer user is issued a username and a password. The mobile computer user then uses the username and password to print on a printer within the enrollment base service system. The user, identified by the username, is charged for the printing service. For example, a university issues a username and password to a student. The student may print on any printer in the university system by first entering the username and password on the printer. The university tracks the printing of the student and charges the student for the printing. This solution allows the mobile computer user to print from only those printers within the enrollment based service system.

In a printing shop solution, the mobile computer user must transfer a document to a portable storage device, such as a floppy disk, a tape cartridge, or a compact disk. The portable storage device is delivered to the printing shop. The document is then transferred to a computer at the print shop and printed to one of the printers at the print shop. The user must then pay the print shop for the printing service. This solution is often time consuming and inconvenient.

### SUMMARY OF THE INVENTION

According to principles of the present invention, an electronic document is transferred to print media in exchange for payment. Payment account information is discovered. The payment account information is optionally verified. Either after receiving the payment account information or after verifying the payment account information, the output apparatus is activated to accept the electronic document. Either after discovering the payment account information, verifying the payment account information, or activating the output apparatus, an electronic document is accepted. The electronic document is transferred to print media. A price is determined for accepting the electronic document and transferring the electronic document to print media. A payment transaction is executed with the payment information, at the determined price.

According to further principles of the present invention, the payment account information is discovered either by reading the payment account information from an encoded magnetic strip or an optical strip or by receiving a transmission including the payment account information. The electronic document is accepted ether by receiving a transmission including the electronic document or copying the electronic document to the output apparatus.

### DESCRIPTION OF THE DRAWINGS

FIG. 1 is a block diagram representing one embodiment of the output apparatus of the present invention for transferring an electronic document to print media in exchange for payment.

FIG. 2 is a flow chart illustrating one embodiment of the method of the present invention for transferring an electronic document to print media in exchange for payment.

### DETAILED DESCRIPTION OF THE INVENTION

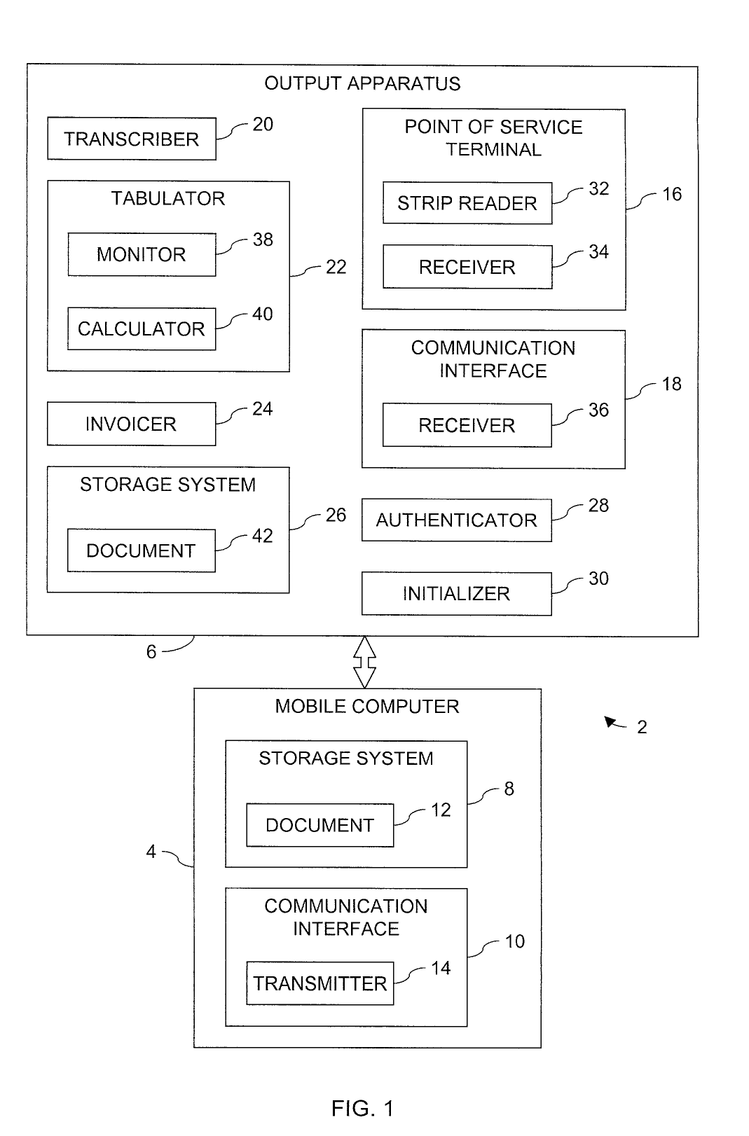

FIG. 1 illustrates one embodiment of a system 2 for transferring an electronic document to print media in exchange for payment. System 2 includes a mobile computer 4 and an output apparatus 6.

Mobile computer 4 is any portable device or system acting as a computer. Examples of mobile computer 4 include a laptop computer, a handheld computer, and a tablet computer. In one embodiment, mobile computer 4 includes storage system 8 and communication interface 10.

Storage system 8 is any system for storing data or executable code. Executable code is any code executable by a processor (not shown). Examples of executable code include software, firmware, and hardwired code.

Storage system 8 may be any type of storage media such as magnetic, optical, or electronic storage media. Storage system 8 is illustrated in FIG. 1 as a single device. Alternatively, storage system 8 may include a plurality of devices. Furthermore, each device of storage system 8 may be embodied in a different media type. For example, one device of storage system 8 may be a magnetic storage media while another device of storage system 8 is an electronic storage media.

Stored in storage system 8 is document 12. Electronic document 12 is any type of document suitable for use by an electronic device and for transferring to print media. Examples of electronic document 12 include a text document, a graphic document, and a document having both text and graphic components.

Communication interface 10 is any device or system configured to transmit electronic document 12. In one embodiment, communication interface 10 includes transmitter 14. In one embodiment, transmitter 14 is any device or system configured to send a transmission including electronic document 12. In a further embodiment, transmitter 14 is any device or system configured to additionally send a transmission including payment account information. Examples of payment account information include a credit card number, a debit card number, and a checking account number with a bank routing number. Examples of transmitter 14 include an infrared transmitter and a radio frequency transmitter.

Output apparatus 6 is any device or system for transferring an electronic document to print media. Examples of output apparatus 6 include a printer, a facsimile machine, and a multifunction device. Output apparatus 6 includes point of service terminal 16, communication interface 18, transcriber 20, tabulator 22, invoicer 24, storage system 26, and optionally, authenticator 28 and initializer 30.

Point of service terminal 16 is any device or system configured to discover payment account information. In one embodiment, point of service terminal 16 includes strip reader 32. Strip reader 32 is any device or system configured to read the payment account information from an encoded strip. In one embodiment, strip reader 32 is a magnetic strip reader. In an alternate embodiment, strip reader 32 is an optical strip reader.

In an alternate embodiment, point of service terminal 16 includes receiver 34. Receiver 34 is any device or system configured to receive a transmission including the payment account information. Examples of receiver 34 include an infrared receiver and a radio frequency receiver.

Communication interface 18 is any device or system configured to accept an electronic document. In one embodiment, communication interface 18 includes receiver 36. Receiver 36 is any device or system configured to receive a transmission including electronic document 12. Examples of receiver 36 include an infrared receiver and a radio frequency receiver. As illustrated in FIG. 1, receiver 36 and receiver 34 are separate devices. Alternatively, receiver 36 and 34 are the same device configured to receive both a transmission including the payment account information and a transmission including electronic document 12 or a single transmission including both the payment account information and electronic document 12.

A copy of electronic document 12 is represented in output apparatus 6 as electronic document 42. Electronic document 42 is stored on storage system 26.

Storage system 26 is any system for storing data or executable code. Storage system 26 may also be a program storage system 26 tangibly embodying a program, applet, or instructions executable by a processor (not shown) for performing the method steps of the present invention executable by the processor. Storage system 26 may be any type of storage media such as magnetic, optical, or electronic storage media. Storage system 26 is illustrated in FIG. 1 as a single device. Alternatively, storage system 26 may include a plurality of devices. Furthermore, each device of storage system 26 may be embodied in a different media type. For example, one device of storage system 26 may be a magnetic storage media while another device of storage system 26 is an electronic storage media.

Transcriber 20 is any combination of hardware and executable code configured to transfer electronic document 42 to print media. Examples of transcriber 20 include imaging systems of a printer, a mopier, and a facsimile machine.

Tabulator 22 is any combination of hardware and executable code configured to determine a price for both accepting the electronic document and transferring the electronic document to print media. In one embodiment, tabulator 22 includes monitor 38 and calculator 40. Monitor 38 is any combination of hardware and executable code configured to count a number of pages of print media used by electronic document 42. Calculator 40 is any combination of hardware and executable code configured to multiply a price per page by the number of pages of print media used by document 42.

Invoicer 24 is any combination of hardware and executable code configured to execute a payment transaction with the payment information, at the determined price. Authenticator 28 is any combination of hardware and executable code configured to verify the payment account information.

Initializer 30 is any combination of hardware and executable code configured to respond to discovering the payment account information by activating output apparatus 6 to accept and output electronic document 42. Alternatively, initializer 30 is any combination of hardware and executable code configured to respond to verifying the payment account information by activating output apparatus 6 to accept and output electronic document 42. In one embodiment invoicer 24, autheticator 28, and initializer 30 are each embodied in executable code executed on a processor.

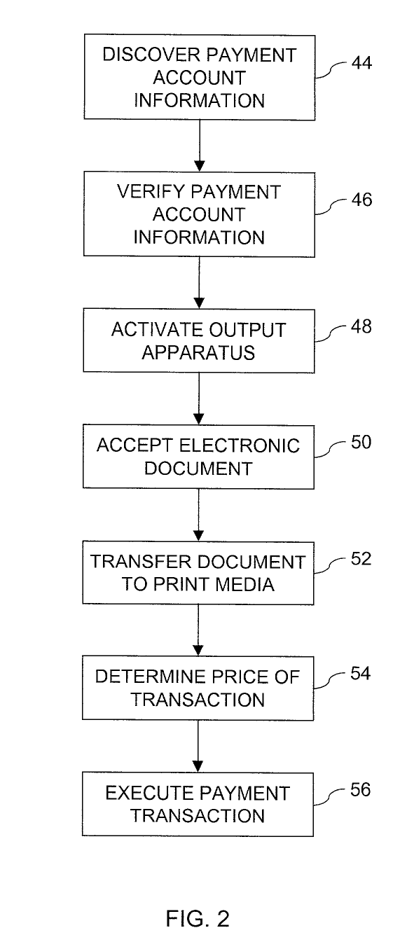

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

Payment account information is discovered 44. In one embodiment, payment account information is discovered 44 by receiving a transmission including the payment account information. In an alternate embodiment, payment account information is discovered 44 by reading the payment account information from an encoded strip. Examples of an encoded strip include a magnetic strip and an optical strip.

Optionally, the payment account information is verified 46. Verifying the payment account information includes discovering whether the payment account information refers to an existing, valid account. Optionally, Verifying the payment account information further includes confirming authority to use the account referred to by the payment account information.

In response to receiving the payment account information, the output apparatus is activated 48 to accept and output the electronic document. In an alternate embodiment, the output apparatus is activated 48 in response to a verification that the payment account information refers to an existing, valid account.

Electronic document 12 is accepted 50 and stored in storage system 26 as electronic document 42. In one embodiment, electronic document 12 is accepted 50 by receiving a transmission including electronic document 12. In one embodiment, the payment account information and electronic document 12 are received in the same transmission. In an alternate embodiment the payment account information and electronic document 12 are received in different transmissions. Examples of transmissions include an infrared transmission, a radio frequency transmission, and a hardwire transmission.

Electronic document 42 is transferred 52 to print media. A price is determined 54 for accepting electronic document 12 and transferring electronic document 42 to print media. In one embodiment, the price is determined 54 by counting the number of pages of print media used by document 42 and multiplying the number of pages by a price per page.

A payment transaction is executed 56 with the payment information, at the determined price. In one embodiment, the payment transaction is executed 56 by debiting or initiating a debit of a debit card account. In an alternate embodiment, the payment transaction is executed 56 by reducing or initiating a reduction of the credit balance of a credit card account. In still another embodiment, the payment transaction is executed 56 by reducing or initiating a reduction of the balance of a checking account.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for transferring an electronic document to print media in exchange for payment, the method comprising:
(a) discovering payment account information;
(b) accepting an electronic document;
(c) transferring the electronic document to print media;
(d) determining a price for accepting the electronic document and transferring the electronic document to print media; and,
(e) executing a payment transaction with the payment information, at the determined price.

2. The method of claim 1 wherein discovering the payment account information includes reading the payment account information from an encoded strip selected from the group consisting of a magnetic strip and an optical strip.

3. The method of claim 1 wherein discovering the payment account information includes receiving a transmission including the payment account information.

4. The method of claim 1 wherein accepting an electronic document includes receiving a transmission including the electronic document.

5. The method of claim 1 wherein determining a price for receiving and transferring the electronic document includes:
(a) counting a number of pages of the electronic document; and,
(b) multiplying the number of pages by a price per page

6. The method of claim 1 further including verifying the payment account information.

7. The method of claim 1 further including responsive to discovering the payment account information, activating the output apparatus to accept the electronic document and transfer the electronic document to print media.

8. An output apparatus for transferring an electronic document to print media in exchange for payment, the system comprising:
(a) a point of service terminal configured to discover payment account information;
(b) a communication interface configured to accept an electronic document;
(c) a transcriber configured to transfer the electronic document to print media;
(d) a tabulator configured to determine a price for accepting the electronic document and transferring the electronic document to print media; and,
(e) an invoicer configured to execute a payment transaction with the payment information, at the determined price.

9. The output apparatus of claim 8 wherein the point of service terminal includes a strip reader configured to read the payment account information from an encoded strip selected from the group consisting of a magnetic strip and an optical strip.

10. The output apparatus of claim 8 wherein the point of service terminal includes a receiver configured to receive a transmission including the payment account information.

11. The output apparatus of claim 8 wherein the communication interface includes a receiver configured to receive a transmission including the electronic document.

12. The output apparatus of claim 8 wherein the tabulator includes:
(a) a monitor configured to count a number of pages of the electronic document; and,
(b) a calculator configured to multiply the number of pages by a price per page

13. The output apparatus of claim 8 further including an authenticator configured to verify the payment account information.

14. The output apparatus of claim 8 further including an initializer configured to respond to discovering the payment account information by activating the output apparatus to accept the electronic document and transfer the electronic document to print media.

15. A program storage system readable by a computer, tangibly embodying a program, applet, or instructions executable by the computer to perform method steps for transferring an electronic document to print media in exchange for payment, the method steps comprising:
(a) discovering payment account information;
(b) accepting an electronic document;
(c) transferring the electronic document to print media;
(d) determining a price for accepting the electronic document and transferring the electronic document to print media; and,
(e) executing a payment transaction with the payment information, at the determined price.

16. The program storage system of claim 15 wherein the method step of discovering the payment account information includes reading the payment account information from an encoded strip selected from the group consisting of a magnetic strip and an optical strip.

17. The program storage system of claim 15 wherein the method step of discovering the payment account information includes receiving a transmission including the payment account information.

18. The program storage system of claim 15 wherein the method step of accepting an electronic document includes receiving a transmission including the electronic document.

19. The program storage system of claim 17 wherein the method steps further include verifying the payment account information.

20. The program storage system of claim 15 wherein the method steps further include responsive to discovering the payment account information, activating the output apparatus to accept the electronic document and transfer the electronic document to print media.
